(19) United States
(12) Patent Application Publication
(10) Pub. No.: US 2017/0306977 A1
(43) Pub. Date: Oct. 26, 2017

(54) Compressor Having a Variable Diffuser Width

(71) Applicant: CONTINENTAL AUTOMOTIVE GMBH, Hannover (DE)

(72) Inventor: Jan Ehrhard, Wiesloch (DE)

(73) Assignee: CONTINENTAL AUTOMOTIVE GMBH, Hannover (DE)

(21) Appl. No.: 15/613,690

(22) Filed: Jun. 5, 2017

Related U.S. Application Data
(63) Continuation of application No. PCT/EP2015/074699, filed on Oct. 26, 2015.

(30) Foreign Application Priority Data
Dec. 5, 2014 (DE) 10 2014 224 963.5

(51) Int. Cl. F04D 29/46; F02B 37/22; F04D 17/10; F04D 27/00

(52) U.S. Cl. CPC F04D 29/464; F04D 27/002; F02B 37/225; F04D 17/10

(57) ABSTRACT

The disclosure relates to a compressor for an exhaust gas turbocharger. The compressor includes a compressor wheel, a compressor housing having a volute and a diffuser, and a device for modifying the diffuser width. The device for modifying the diffuser is configured to automatically alter the diffuser width as a function of one or more current operating parameters of the compressor.

### CROSS-REFERENCE TO RELATED APPLICATIONS

This application claims the benefit of PCT Application PCT/EP2015/074699, filed Oct. 26, 2015, which claims priority to German Application DE 10 2014 224 963.5, filed Dec. 5, 2014. The disclosures of the above applications are incorporated herein by reference.

### TECHNICAL FIELD

The disclosure relates to a compressor having a variable diffuser width.

### BACKGROUND

In exhaust gas turbochargers, compressors which are embodied as radial compressors are mainly used. In particular, when exhaust gas turbochargers are used in passenger car engines, the characteristic diagram width of the compressor is an important criterion for the possibility of attaining the target values for the engine. The characteristic diagram width of these compressors is essentially determined by the geometry of the compressor wheel and by the geometry of the diffuser. What is referred to as compressor pumping, which occurs when the pumping limit is exceeded, is frequently triggered by flow detachment in the diffuser. Modifying the diffuser geometry for the purpose of characteristic diagram stabilization frequently brings about disadvantages at high rotational speeds, i.e. in the region of the fill limit.

In exhaust gas turbochargers that are already commercially employed in motor vehicles, compressors are generally used, the diffusers of which have an invariable diffuser width which is predefined by the manufacturer. Compressors with such diffusers with invariable diffuser width can be manufactured at comparatively low cost and have a high level of robustness during operation. However, in this context, a compromise is made with respect to the characteristic diagram width.

DE 102 13 897 A1 has already disclosed a variable turbocharger for an internal combustion engine, which turbocharger has an exhaust gas turbine and a compressor with a variable swirl and/or throttle device. This exhaust gas turbocharger is formed by a housing and by means of a compressor wheel that is connected to an exhaust gas turbine wheel via a shaft. The compressor has just one inflow duct in which the variable swirl and throttle device is arranged upstream of the compressor wheel. This variable swirl and throttle device is embodied as a radially oriented variable inlet guide grating, which is arranged directly upstream of a compressor vane arrangement. Furthermore, the known compressor has, directly downstream of the compressor wheel vanes, a diffuser with a variable vane arrangement and rotatable diffuser vanes, with which the behavior of the compressor in respect of the pumping limit and fill limit can be influenced. A closed- and open-loop control unit picks up actual value signals of the internal combustion engine and outputs control signals to the variable inlet guide grating and the diffuser.

DE 10 2011 120 168 A1 discloses a compressor for an exhaust gas turbocharger at whose compressor wheel outlet an adjustment device is arranged by means of which flow parameters at the compressor wheel outlet can be influenced. This adjustment device is axially adjustable and has such a radial extent into the diffuser region that the diffuser width can be changed by actuating the adjustment device simultaneously with respect to the compressor wheel outlet. For activating the adjustment device an actuator is provided which is embodied as an electric motor or as a pressure box which can be regulated pneumatically and/or hydraulically.

### SUMMARY

The object of the disclosure is to specify a compressor with a variable diffuser width, which compressor can be manufactured cost-effectively and has a simple design. The advantages of the disclosure include, for example, the fact that, in order to change the diffuser width, a compressor according to the disclosure does not require any active elements such as, for example, an electric motor for adjusting adjustable elements. Furthermore, there is no need for a control unit to which sensor signals are fed and which determines control signals for adjustment elements by evaluating these sensor signals. In addition, a compressor according to the disclosure does not require any housing passages for sensor signal lines or control signal lines. This in turn reduces the possibilities of leakage of the compressor.

A further advantage of a compressor according to the disclosure is in the reduced complexity, since it requires fewer components than, for example, a compressor whose diffuser width is changed by using a control unit.

One aspect of the disclosure provides a compressor for an exhaust gas turbocharger. The compressor includes a compressor wheel, a compressor housing that includes a volute and a diffuser, and a device for changing the diffuser width. The device for changing the diffuser width is configured to automatically change the diffuser width as a function of one or more instantaneous operating parameters of the compressor.

Implementations of the disclosure may include one or more of the following optional features. In some implementations, the one or more instantaneous operating parameters of the compressor includes temperature. Additionally, the device for changing the diffuser width may include a bimetal element. In some examples, the housing is a helical housing.

In some implementations, the one or more instantaneous operating parameters of the compressor includes a pressure or a pressure difference. The device for changing the diffuser width may include a spring. In some examples, the spring is arranged between a positionally fixed wall of the diffuser and a positionally variable diffuser width adjustment wall provided for changing the diffuser width and is provided within the housing (e.g., helical housing).

The device for changing the diffuser width may be arranged in the region of the rear wall, lying opposite the air inlet of the compressor housing, of the diffuser. In some examples, the device for changing the diffuser width is arranged in the region of the front wall, facing the air inlet of the compressor housing, of the diffuser. The compressor may be a radial compressor.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary compressor.

FIG. 2 is a schematic view of an exemplary compressor.

Like reference symbols in the various drawings indicate like elements.

### DETAILED DESCRIPTION

An exhaust gas turbocharger used in a motor vehicle uses the exhaust gas energy, which would otherwise be lost, to increase the power of the internal combustion engine provided in the motor vehicle. For this purpose, the exhaust gas turbocharger has a turbine with a turbine wheel which is driven by the exhaust gas flow. The turbine wheel is attached to a shaft, to whose other end the compressor wheel of a compressor is attached. As a result of the rotation of the shaft, the compressor wheel is driven, with the result that air fed to the compressor through its air inlet is accelerated to a high speed in the compressor. The accelerated air is fed to a diffuser arranged between the compressor wheel outlet and the volute of the compressor housing. In the diffuser, the kinetic energy of the accelerated air flow is converted into pressure energy.

The operating behavior of such a compressor is described by means of a compressor characteristic diagram in which the pressure ratio present in the compressor is plotted against the mass flow rate. The working range, present during operation of the exhaust gas turbocharger, in the compressor characteristic diagram is limited on the one side by the pumping limit and on the other side by the fill limit. The pumping limit is that limit of the characteristic diagram at which, as a result of excessively small volume flows and excessively high pressure conditions, the flow becomes detached from the vanes of the compressor wheel and air is not fed any longer. The fill limit characterizes the point when the maximum volume flow is reached.

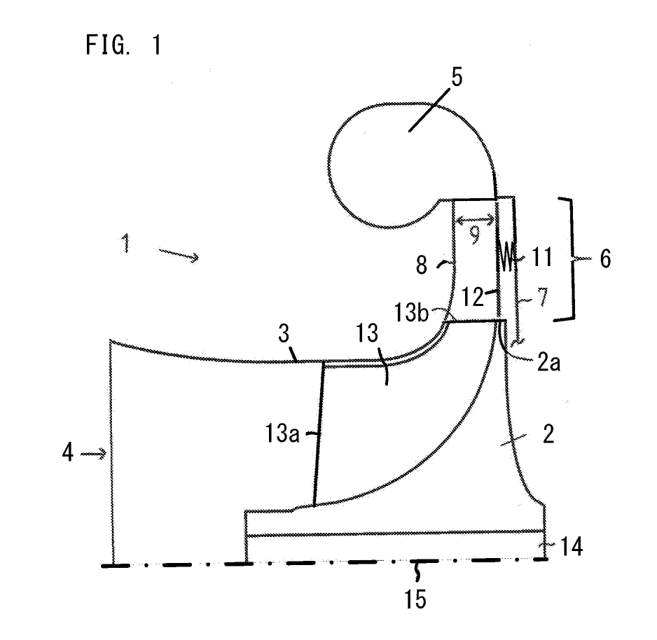

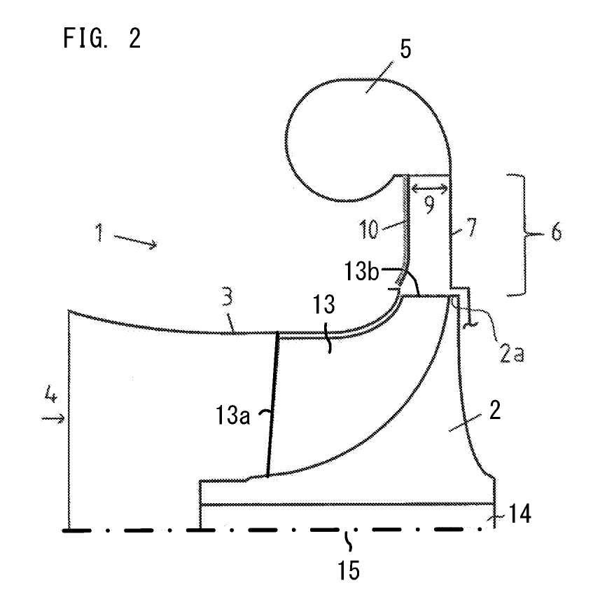

The compressor 1 of the present disclosure described in FIGS. 1 and 2 extends the compressor characteristic diagram in the working mode. The compressor includes a compressor wheel, a compressor housing, which contains a volute and a diffuser, and a device for changing the diffuser width which is a device which automatically changes the diffuser width as a function of one or more instantaneous operating parameters of the compressor. These instantaneous operating parameters are preferably a temperature prevailing in the compressor or a pressure prevailing in the compressor or a pressure difference between the compressor inlet and the diffuser.

The advantages of such a device that changes the diffuser width automatically as a function of instantaneously present operating parameters of the compressor include, for example, the fact that it can be implemented easily and cost-effectively and requires comparatively few components. In some examples, a compressor according to the disclosure does not require, to change the diffuser width, any sensors, any feedlines between sensors and a control unit, any control unit which, by using sensor signals, makes available control signals for changing the diffuser width, or any feedlines between a control unit and the specified components.

FIG. 1 illustrates a compressor 1 according to an aspect of the disclosure. The compressor 1 is a radial compressor. The compressor 1 includes a compressor wheel 2, a compressor housing 3, and a device for changing the diffuser width 9. The compressor housing 3 includes a volute 5 and a diffuser 6.

The compressor wheel 2 includes a shaft hole 14 and can be rotated, in operation, about the rotational axis 15 (shown by dashed lines in FIG. 1) together with a shaft that is inserted into the shaft hole. Furthermore, the compressor wheel 2 has an outlet edge 2a. In addition, compressor wheel vanes 13, which each have an inlet edge 13a and an outlet edge 13b, are provided on the compressor wheel 2.

The compressor housing 3 has an air inlet 4, through which the air which is to be compressed in the compressor 1 enters the compressor housing 3 and is directed there into the region of the compressor wheel 2.

The device for changing the diffuser width 9 is configured to change the diffuser width 9 automatically as a function of an instantaneous operating parameter of the radial compressor 1. In some examples, the operating parameter may be the pressure which prevails in the region of the diffuser 6 of the compressor 1 or a pressure difference between the air inlet 4 of the compressor 1 and the diffuser 6.

The device, which changes the diffuser width 9 automatically as a function of the instantaneous pressure prevailing in the region of the diffuser 6 or the specified pressure difference, may be a spring 11 that interacts with a diffuser width adjustment wall 12. The spring 11 may be arranged between the positionally fixed rear wall 7 of the diffuser 6 and the specified diffuser width adjustment wall 12.

For example, the greater the instantaneous pressure in the diffuser 6, the greater the extent to which the spring 11, which is connected to the diffuser width adjustment wall 12 that can move in the axial direction or bears against the latter, is compressed. As a result, the diffuser width 9, which is present between the positionally fixed front wall 8 of the diffuser 6 and the diffuser width adjustment wall 12, is increased.

In contrast, if the instantaneous pressure in the diffuser 6 decreases, the compressed spring 11 is relaxed and pushes the diffuser width adjustment wall 12 which can move in the axial direction such that the diffuser width 9, which is present between the positionally fixed front wall 8 of the diffuser and the diffuser width adjustment wall 12, is reduced in size.

With continued reference to FIG. 1, the device which changes the diffuser width automatically, i.e., the spring 11 and the diffuser width adjustment wall 12, is arranged in the region of the rear wall 7 of the diffuser 6. Alternatively, it is also possible to arrange the device that automatically changes the diffuser width, i.e., the spring 11 and the diffuser width adjustment wall 12, in the region of the front wall 8 of the diffuser.

FIG. 2 illustrates a compressor 1 according to another aspect of the disclosure. This compressor is a radial compressor.

The device for changing the diffuser width 9 is a device that automatically changes the diffuser width 9 as a function of an instantaneous operating parameter of the radial compressor. The operating parameter may be a temperature which prevails in the region of the diffuser of the compressor.

The device which changes the diffuser width automatically as a function of the temperature which is instantaneously prevailing in the region of the diffuser may be a bimetal element 10 whose length also changes when the temperature changes.

In some examples, the bimetal element 10 forms the front wall of the diffuser 6 that is facing the air inlet 4 of the compressor housing 3.

The higher the instantaneous temperature in the diffuser, the greater the extent to which the bimetal element 10 lengthens, and the greater the extent to which the lower end region of the bimetal element 10, whose upper end region is attached to the volute 5, is deflected to the left in FIG. 2. As a result, the diffuser width 9, which is present between the positionally fixed rear wall 7 of the diffuser 6 and the bimetal element 10, is increased in this lower region of the diffuser 6.

If the instantaneous temperature drops in the diffuser 6, the length of the bimetal element 10 is reduced, so that the diffuser width in the lower region of the diffuser is reduced again.

With continued reference to FIG. 2, the device that changes the diffuser width automatically, i.e., the bimetal element 10, is arranged in the region of the front wall of the diffuser 6. Alternatively, it is also possible to arrange the device which changes the diffuser width automatically, i.e., the bimetal element 10, in the region of the rear wall of the diffuser 6.

A number of implementations have been described. Nevertheless, it will be understood that various modifications may be made without departing from the spirit and scope of the disclosure. Accordingly, other implementations are within the scope of the following claims.

What is claimed is:

1. A compressor for an exhaust gas turbocharger, the compressor comprising:
a compressor wheel;
a compressor housing including a volute and a diffuser, the diffuser having a diffuser width; and
a device for changing the diffuser width configured to automatically change the diffuser width as a function of one or more instantaneous operating parameters of the compressor.

2. The compressor of claim 1, wherein the one or more instantaneous operating parameters of the compressor comprises temperature.

3. The compressor of claim 2, wherein the device for changing the diffuser width comprises a bimetal element.

4. The compressor of claim 1, wherein the one or more instantaneous operating parameters of the compressor comprises a pressure or a pressure difference.

5. The compressor of claim 4, wherein the device for changing the diffuser width comprises a spring.

6. The compressor of claim 5, wherein the spring is arranged between a positionally fixed wall of the diffuser and a positionally variable diffuser width adjustment wall provided for changing the diffuser width and is provided within the compressor housing.

7. The compressor of claim 1, wherein the device for changing the diffuser width is arranged in a region of the rear wall, lying opposite an air inlet of the compressor housing, of the diffuser.

8. The compressor of claim 1, wherein the device for changing the diffuser width is arranged in a region of the front wall, facing an air inlet of the compressor housing, of the diffuser.

9. The compressor of claim 1, wherein the compressor is a radial compressor.
